(19) United States
(12) Patent Application Publication
(10) Pub. No.: US 2009/0018790 A1
(43) Pub. Date: Jan. 15, 2009

(54) ENCODER APPARATUS AND CALIBRATION METHOD OF THE SAME APPARATUS

(75) Inventor: Kyoung-mok Yl, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/957,776

(22) Filed: Dec. 17, 2007

(30) Foreign Application Priority Data
Jul. 13, 2007 (KR) 2007-70597

(51) Int. Cl. G06F 15/00; G01B 11/14

(52) U.S. Cl. 702/94; 356/614; 702/150

(57) ABSTRACT

An encoder apparatus to measure a position of an object from an input analogue signal includes a driving plate which varies according to the position of the object, an optical device to receive a light response from the driving plate and to output a sinusoidal wave analogue signal according to an amount of the driving plate's movement, an analogue to digital (A/D) converter to output a normalized sinusoidal wave digital signal converted from the analogue signal outputted from the optical device, and a calibration unit to convert the sinusoidal wave digital signal outputted from the A/D converter into a triangular wave signal.

### CROSS-REFERENCE TO RELATED APPLICATIONS

This application claims priority under 35 U.S.C. §119(a) from Korean Patent Application No. 10-2007-0070597, filed on Jul. 13, 2007 in the Korean Intellectual Property Office, the disclosure of which is hereby incorporated herein in its entirety by reference.

### BACKGROUND OF THE INVENTION

1. Field of the Invention

The present general inventive concept relates to an encoder apparatus and a calibration method of the same apparatus, and more particularly, to an encoder apparatus and a calibration method of the encoder apparatus to sense and measure a microscopic movement of an object by converting a sinusoidal wave signal output from an optical device to a triangular wave signal.

2. Description of the Related Art

An apparatus requiring a precise control generally adopts a two channel analogue encoder for a precise transfer of an object to be moved.

For example, an image forming apparatus like an inkjet printer typically controls a feeding roller by distinguishing a rotational position of the feeding roller in order to meet a precise transfer of a printing medium for an enhanced printing quality. For this purpose, a two channel analogue encoder capable of outputting sinusoidal wave signals for the respective channels is adopted.

FIG. 1 illustrates a general schematic configuration of a conventional two channel analogue encoder apparatus.

Referring to FIG. 1, the analogue encoder apparatus includes a rotating plate 1 having a slit transmitting an incident light or a reflection band 1a, and an optical device 3 that receives the light transmitted through the slit or reflected from the reflection band 1a and changing according to a rotating amount of the rotating plate 1 and converts the light to an electric signal. The electric signal detected through the optical device 3 is the sinusoidal wave signal as illustrated in FIG. 2. In the case of two channels, the sinusoidal wave signals are output in different phase.

The sinusoidal wave analogue signal is converted to a digital signal of a particular stage by an analogue to digital (A/D) converter 5. Meanwhile, because the analogue output of the analogue encoder apparatus is a sinusoidal wave signal, there is a problem of a different increase in the digital signal depending on an output level of the analogue signal. This problem is examined in detail with reference to FIG. 2.

FIG. 2 is a graph illustrating a form of an output wave when the output of the analogue encoder apparatus is a sinusoidal wave. When the rotating plate 1 is rotated in constant angular speed, the form of the output wave is a sinusoidal wave of a constant period.

Here, a precise amount of the rotating plate 1 movement can be obtained only if the change of the movement is uniform for a certain time period of the constant angular speed. However, if a sinusoidal wave is output, an output amount of the sinusoidal wave for a certain time period is not uniform. For example, if the time is equally divided in six time periods as illustrated in FIG. 2 and the output amounts of the sinusoidal wave corresponding to the respective time periods are compared, the output amounts are not uniform as illustrated in Table 1.

TABLE 1

| Time | output value |
|---|---|
| 0~t₁ | 1.1(=1 + 0.1) |
| t₁~t₂ | 1.7(=0.9 + 0.8) |
| t₂~t₃ | 1.0(=0.2 + 0.8) |
| T₃~t₄ | 1.2(=0.2 + 1) |
| T₄~t₅ | 1.6(=1 + 0.6) |
| T₅~t₆ | 0.8(=0.4 + 0.4) |

As illustrated in Table 1, the encoder apparatus using a sinusoidal wave for measuring the microscopic movement of the object directly from the converted output signal of the A/D converter 5 has a limited detectability due to an inconsistency of the output value depending on the time period.

Accordingly, in order to precisely sense the positional change of an object to be measured, for example, to precisely sense the rotational change of a printing medium feeding roller of an inkjet printer, an improved operation of the position calibration part 7 is required.

### SUMMARY OF THE INVENTION

The present general inventive concept provides an encoder apparatus and a calibration method of the encoder apparatus that can sense a microscopic movement of an object to be measured by converting an output sinusoidal wave signal from an optical device to a triangular wave signal.

Additional aspects and/or utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing an encoder apparatus that measures a position of an object from an input analogue signal, including a driving plate to vary according to the position of the object, an optical device to receive a light response from the driving plate and to output a sinusoidal wave analogue signal according to an amount of the driving plate's movement, an analogue to digital (A/D) converter to output a normalized sinusoidal wave digital signal converted from the analogue signal outputted from the optical device, and a calibration unit to convert the sinusoidal wave digital signal outputted from the A/D converter into a triangular wave signal.

The optical device may output the analogue signals in at least two channels.

The A/D converter may output sine function output level signals having values between −1 and +1, respectively.

The calibration unit may include an inverse function converting part to output a calculated linear function by applying an inverse sine function to each of the sine function output level signals.

The calibration unit may further include a direction calculating part to detect whether a sign of the linear function outputted by the inverse function converting part changes in a predetermined time period, and to calculate information related to an increase/decrease direction of an encoder step, and a position adjusting part to output a first position value according to the information related to the increase/decrease direction of the encoder step calculated in the direction calculating part.

The calibration unit may further include a second position acquiring part to select one of the two channels outputted in the inverse function converting part and to output a second position value by taking an absolute value of the selected channel output value converted in accordance with a resolution of the A/D converter.

The calibration unit may further include a position calculating part to calculate the position of the object by summing the first position value and the second position value.

The foregoing and/or other aspects and utilities of the present general inventive concept can also be achieved by providing a calibration method of an encoder apparatus to measure a position of an object from an input analogue signal, including outputting a normalized sinusoidal wave digital signal which is converted from a sinusoidal wave analogue signal which varies according to the position of the object, converting the normalized sinusoidal wave digital signal into a triangular wave signal, and calculating the position of the object from the converted triangular wave signal.

The sinusoidal wave analogue signal may be obtained in at least two channels.

The outputting the normalized sinusoidal wave digital signal may include calibrating to calculate encoder level maximum values and encoder level minimum values of the respective channels by driving the encoder apparatus in constant speed, and converting to sine function output levels of the respective channels having values between −1 and +1 by using the encoder level maximum values and the encoder level minimum values of the respective channels.

The converting to the triangular wave signal may include outputting a linear function by applying an inverse sine function to each of the sine function output levels of the respective channels.

The calculating the position of the object may include determining whether respective signs of the output linear functions in a predetermined time period are changed, calculating information related to an increase direction or a decrease direction of an encoder step, and outputting a first position value by adjusting a position according to the calculated information related to the increase direction or the decrease direction of the encoder step.

The calculating the position of the object may further include selecting one linear function of one channel from the output linear functions of the two channels, quantizing an output value of the selected channel, and outputting a second position value by converting the quantized output value proper for a resolution of a resolution of an analogue-to-digital converter, thereby calculating the position of the object through summing the first position value and the second position value.

The foregoing and/or other aspects and utilities of the present general inventive concept may also be achieved by providing an encoder apparatus to measure movement of an object, including an optical device to output at least one sinusoidal wave signal according to the movement of the object, and a calibration unit to convert the at least one sinusoidal wave signal into a linear wave signal to calculate position values of the object.

The position values may include a first position value related to a progressing direction of the object, a second position value related to a magnitude of the object's movement, and an actual position value based on a summation of the first position value and the second position value.

The encoder apparatus may further include an A/D converter having a predetermined resolution value, wherein the first position value is calculated through addition or subtraction of the resolution value with respect to a prior position of the object based on the progressing direction of the object, and the second position value is calculated by quantizing a selected part of the linear wave signal in accordance with the resolution value.

The progressing direction may be determined by comparing the slope and sign of selected parts of the linear wave signals.

The foregoing and/or other aspects and utilities of the present general inventive concept may also be achieved by providing a calibration method to measure movement of an object, including outputting at least one sinusoidal wave signal according to the movement of the object, converting the at least one sinusoidal wave signal into a linear wave signal, and calculating position values of the object based on a selected part of the linear wave signal.

The selected part of the linear wave signal may correspond with a progressing direction of the object in a predetermined time period.

### BRIEF DESCRIPTION OF THE DRAWINGS

These and/or other aspects and utilities of the present general inventive concept will become apparent and more readily appreciated from the following description of the embodiments, taken in conjunction with the accompany drawings of which:

FIG. 1 illustrates a schematic configuration of a general two channel analogue encoder apparatus;

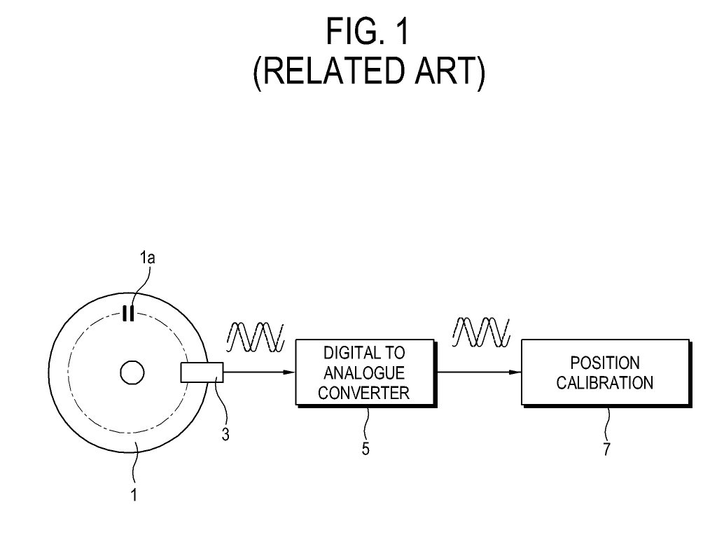

FIG. 2 is a graph illustrating a form of an output wave when the output of the analogue encoder apparatus is a sinusoidal wave;

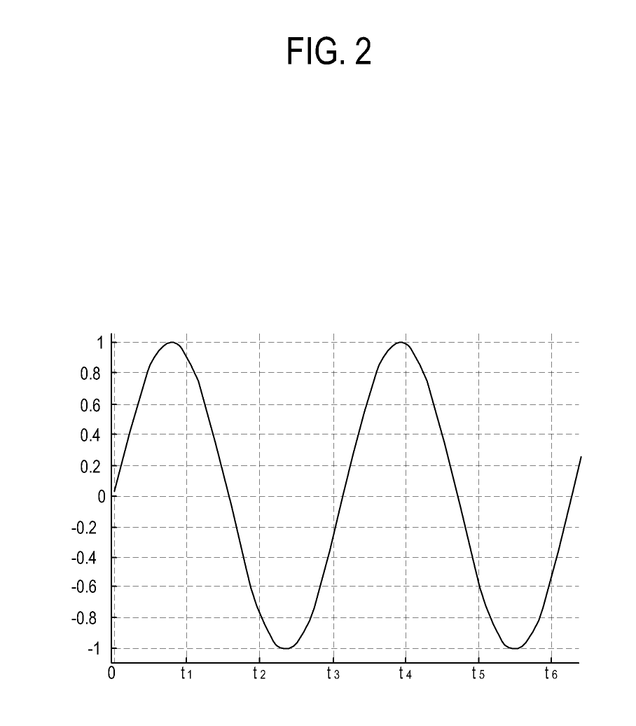

FIG. 3 illustrates a schematic configuration of an encoder apparatus according to an embodiment of the present general inventive concept;

FIG. 4 is a graph illustrating a principle of converting an output level signal of a sine function to a linear function by applying an inverse sine function to the sine function;

FIG. 5 is a flow chart illustrating a calibration operation of the encoder apparatus according to an embodiment of the present general inventive concept;

FIG. 6 is an A/D converted data graph from the two channel analogue encoder;

FIG. 7 is a graph illustrating a normalized shape of the respective channel sine functions sine_a and sine_b having values between −1 and +1 respectively;

FIG. 8 is a graph illustrating respective channel inverse sine functions, arcsine_a and arcsine_b, respectively, having linear function values;

FIG. 9 is a graph comparing the sine inverse function before and after the conversion;

FIG. 10 is a graph illustrating a process of determining the encoder progressing direction and an amount of change in the time periods I, II, III AND IV;

FIG. 11 is a graph explaining a process of calculating a second position value; and

FIG. 12 is a graph illustrating a result of summing a first position value (pos_1) and a second position value (pos_2).

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

An encoder apparatus according to an embodiment of the present general inventive concept may be used, for example, to precisely measure an object position in an image forming apparatus by measuring a rotated amount of a feeding roller of the image forming apparatus with an input analogue signal.

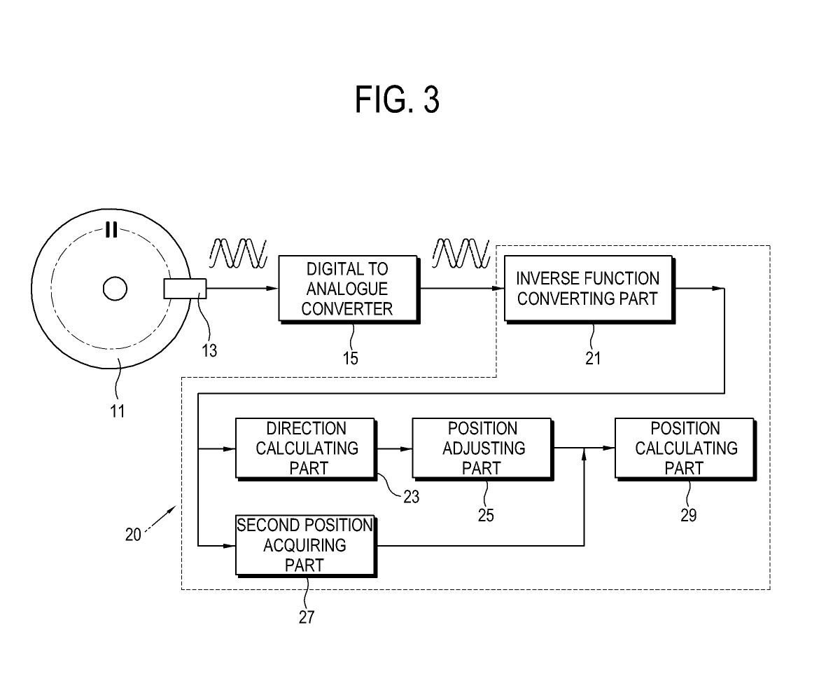

Referring to FIG. 3, an encoder apparatus in accordance with an embodiment of the present general inventive concept may include a driving plate 11 to vary with the position of the object, an optical device 13 to output a sinusoidal wave analogue signal which varies according to the movement of the driving plate 11, an analogue to digital (A/D) converter (hereinafter A/D converter) 15 to convert and output the analogue signal output from the optical device 13 into a normalized sinusoidal wave digital signal, and a calibration unit 20 to convert the output sinusoidal wave signal from the A/D converter 15 into a triangular wave signal.

The driving plate 11 may include plural slits transmitting an incident light or plural reflection bands reflecting an incident light. The optical device 13 may be disposed to face the driving plate 11 and may transmit a light beam to the driving plate 11. The optical device 13 may receive a light response from the driving plate, which may include the light transmitted through the slits which may vary according to the movement of the driving plate 11, or the light reflected from the reflection band. The optical device 13 then converts the received light into an electrical signal. Here, the detected electrical signal of the optical device 13 may be a sinusoidal wave signal of an analogue signal as illustrated in FIG. 3. In one aspect of the present general inventive concept, the optical device 13 may detect the sinusoidal wave analogue signal in two or more channels.

The output signals from the A/D converter 15 may be output level signals of a sine function having values between −1 and +1, respectively.

The calibration unit 20 may convert the sine function level output signal output from the A/D converter 15 into a triangular wave signal. To do so, the calibration unit 20 may include an inverse function converting part 21 to output a calculated linear function based on an inverse sine function of the respective sine function output levels

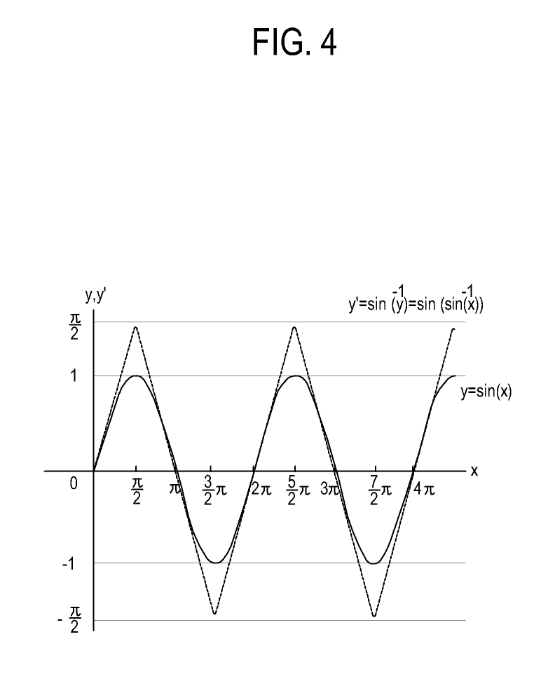

FIG. 4 is a graph illustrating a principle of converting an output level signal of a sine function to a linear function by applying an inverse sine function to the sine function.

The output signal from the A/D converter 15 may be a sine wave signal having values between −1 and +1. Accordingly, it is possible to express the signal as a sine function in the form of y=sin(x).

The inverse function of the sine function y=sin(x) can be expressed as y′=sin⁻¹(y), and draws a triangular linear graph as illustrated in FIG. 4 having a value range between −π/2 and +π/2. Accordingly, the amount change in each time period can be made uniform if the sine function is inversed to be expressed in a linear function.

Accordingly, the encoder apparatus according to the present general inventive concept may obtain a linear function from the two channel analogue signals through the inverse function converting part 21, and may use the linear function to acquire precise position information of the object through calibration.

The calibration unit 20 may further include a direction calculating part 23 to calculate a movement direction of the driving plate 11 of the encoder apparatus and a position adjusting part 25 to output a first position value.

The direction calculating part 23 may calculate information related to an increase or decrease direction of the encoder step through sensing whether the respective signals of the linear functions output in the inverse function converting part 21 change. For example, if a rotating plate is adopted as the driving plate 11 of the encoder apparatus, the direction calculating part 23 may calculate whether it is clockwise or counterclockwise rotation of the driving plate 11 following the increase or decrease direction of the encoder step.

The adjusting part 25 may adjust the object position by increasing or decreasing the step amount with respect to a prior position of the object according to the increase or decrease direction calculated by the direction calculating part 23, and may output a first position value compensated through addition or subtraction of the step amount with respect to the prior position. For example, if an A/D converter having 256 steps resolution is adopted as the A/D converter 15 together with adopting a rotating plate as the driving plate 11, the encoder step amount may be increased 256 from the prior position when it is calculated that the rotation plate is rotated in a clockwise direction, and may be decreased 256 from the prior position when it is calculated that the rotation plate is rotated in a counterclockwise direction. If there is no change in the step amount, the prior position value may be outputted as the first position value.

The calibration unit 20 may further include a second position value acquiring part 27. The second position acquiring part 27 may select any one channel between the two channels outputted from the inverse function converter 21, and may output a second position value (ADC_pos) based on the resolution of the A/D converter 15 after taking an absolute value of the selected channel output value.

For example, as discussed above, if the A/D converter 15 has a resolution of 256, and if the sin⁻¹(y) output range is between −π/2(≈−1.57) to π/2(≈1.57), then the second position value (ADC_pos) in the case of clockwise rotation may be calculated as ADC_pos=256/1.57*|sin⁻¹(y)|. Likewise, in the case of counterclockwise rotation, the second position value may be calculated as ADC_pos=256−256/1.57*|sin⁻¹(y)|.

In accordance with the present general inventive concept, the calibration unit 20 may further include a position calculating part 29 to sum the first position value and the second position value to obtain an actual position value of the object, thus enabling the encoding apparatus to precisely control the position of an object in real time from the summed value.

Accordingly, a calibration method of the encoder apparatus in accordance with an embodiment of the present general inventive concept will now be described below.

As described herein, it is understood that the calibration method of the present general inventive concept may be applied to an analogue encoder apparatus to more precisely measure the position of an object from an input sinusoidal wave analogue signal by converting the sinusoidal wave signal into a linear (e.g., triangular) wave signal.

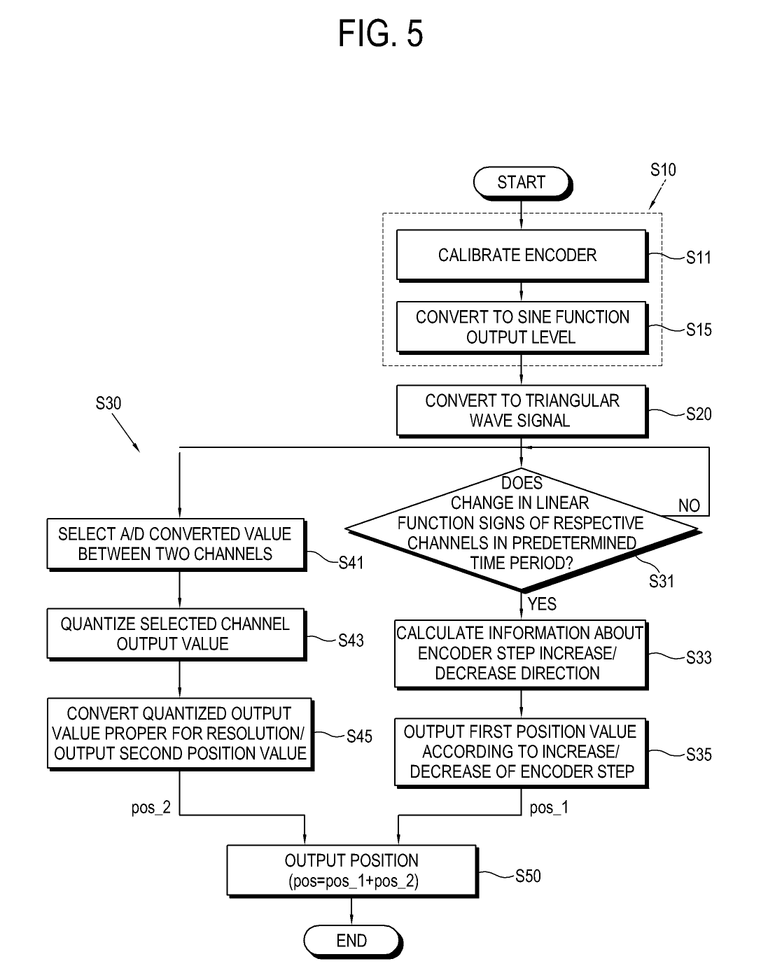

Referring to FIG. 5, the calibration method may include outputting a normalized sinusoidal wave digital signal converted from a sinusoidal wave analogue signal that varies according to the object position (S10), converting the normalized sinusoidal wave digital signal into a converted triangular wave signal (S20), and calculating the object position by analyzing the converted triangular wave signal (S30).

Here, the sinusoidal wave analogue signal may be an analogue signal that may include two channels, that is, channel a(cha) and channel b(chb). Although the analogue signal according to an embodiment of the present general inventive concept may include two channels, it is understood that more or less channels may be included in the analogue signal without departing from the broader principles and spirit of the present general inventive concept.

Referring to FIG. 5, operation S10 of the normalized sinusoidal wave digital signal may include calibrating the encoder level (S11), and converting to a sine function output level (S15).

S11 may calculate the maximum values and the minimum values of the respective channel encoder levels by driving the encoder apparatus in constant speed.

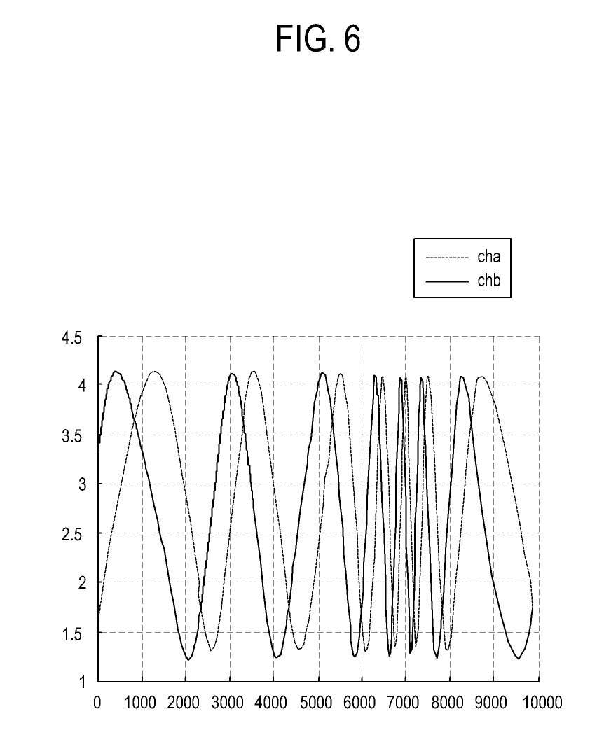

FIG. 6 is an A/D converted data graph from the two channel analogue encoder apparatus. Referring to FIG. 6, it is apparent that the period becomes faster and then, becomes slower again, as time elapses. In other words, based on FIG. 6, it is evident that the speed of the rotation plate is first increased and then decreased as time elapses. It is also illustrated that the graph of FIG. 6 includes a vertical axis representing a value of between about 1.2˜4.2. However, these vertical axis values may be different from real data. That is, if the A/D converter 15 utilizes 256 levels of resolution for data conversion, the vertical axis would actually represent a value of between about 0˜255 to correspond with the resolution value of the A/D converter. Regarding the horizontal axis values, it is illustrated that the horizontal axis of the graph in FIG. 6 may be used to partition time in a predetermined time period without any physical meaning.

In order to obtain a normalized value of the sine inverse function with the data illustrated in FIG. 6, the data may be converted into a sine function that has a value between −1 to +1. For this, the A/D converted maximum values and minimum values of the respective channels should be obtained. For this purpose, it is understood that the respective maximum value and the respective minimum value need only be obtained one time as long as they are not erased in the memory of the encoder apparatus.

Referring now to a process of obtaining the maximum value and the minimum value, the maximum value and the minimum value of the encoder level may be stored from the A/D converted result value through the A/D converter 15 by driving the object in constant speed. The present embodiment may represent the maximum value and the minimum value of channel a (cha) respectively as cha_level_max and cha_level_min. Similarly, the maximum value and the minimum channel of channel b (chb) may be respectively represented as chb_level_max and chb_level_min. In case an error occurs in the maximum value and the minimum value, an experimentally determined set offset value (offset_cha_max, offset_cha_min, offset_chb_max, offset_chb_min) may be added.

Accordingly, the respective channel maximum value and minimum value stored in the memory may be as follows.

cha_level_max=cha_level_max+offset_{—}cha_max

cha_level_min=cha_level_min+offset_{—}cha_min

chb_level_max=chb_level_max+offset_{—}chb_max

chb_level_min=chb_level_min+offset_{—}chb_min

At S15, the A/D converted data of the analogue encoder may be converted into the respective channels sine function output levels of value between −1 and +1 using the respective channel maximum value and minimum value of the encoder levels obtained at S11.

That is, the level values pre-stored in the memory or the calculated analogue encoder level values may be used to convert to sine values (sine_a, sine_b) of between −1˜+1 for the respective channels.

The sine values (sine_a) and (sine_b) converted from the respective channel a value (cha) and b value (chb) may be as follows.

sine_{—}a=(cha−cha_level_min)/cha_{—}h*2−1, −1≦sine_{—}a≦1

sine_{—}b=(chb−chb_level_min)/chb_{—}h*2−1, −1≦sine_{—}b≦1

Here, cha_h represents a difference between the maximum value and the minimum value of the channel a (cha_h=cha_level_max−cha_level_min) and, chb_h represents a difference between the maximum value and the minimum value of the channel b (chb_h=chb_level_max−chb_level_min).

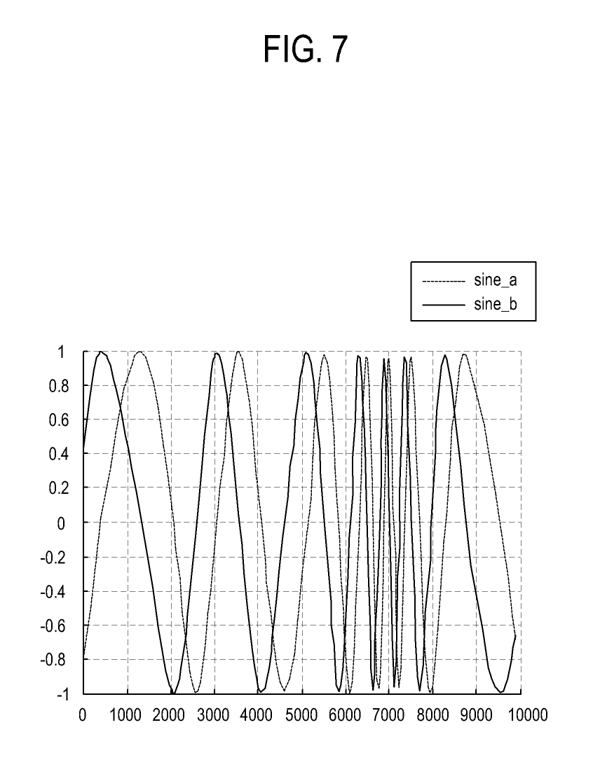

FIG. 7 is a result conversion graph. Referring to FIG. 7, the respective sine functions of the respective channels are illustrated to be normalized in value between −1 and +1.

At S20, the normalized sinusoidal wave signal may be converted to the triangular wave signal (S20) to output the calculated linear function respectively applying the inverse sine function to the sine function output levels.

When applying the inverse sine function to the output value of the sine function, the linear function of output values may be made in the range between −π/2 and +π/2 (−1.57˜1.57) as follows.

arcsine_{—}a=sin⁻¹(sine_{—}a), −π/2<arcsine_{—}a<+π/2

arcsine_{—}b=sin⁻¹(sine_{—}b), −π/2<arcsine_{—}b<+π/2

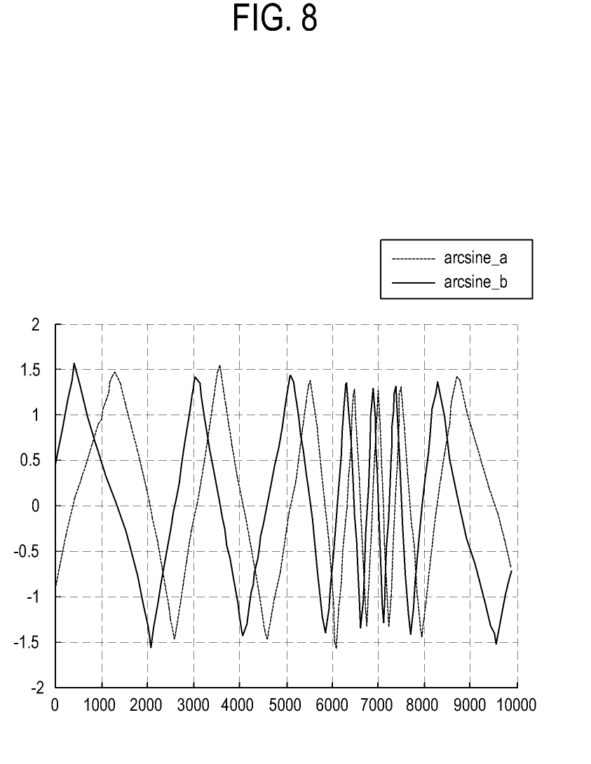

FIG. 8 is a graph illustrating results from the above equations. Referring to FIG. 8, it is apparent that the arcsine_a and arcsine_b representing the inverse sine function of the respective channel a and channel b have linear function values.

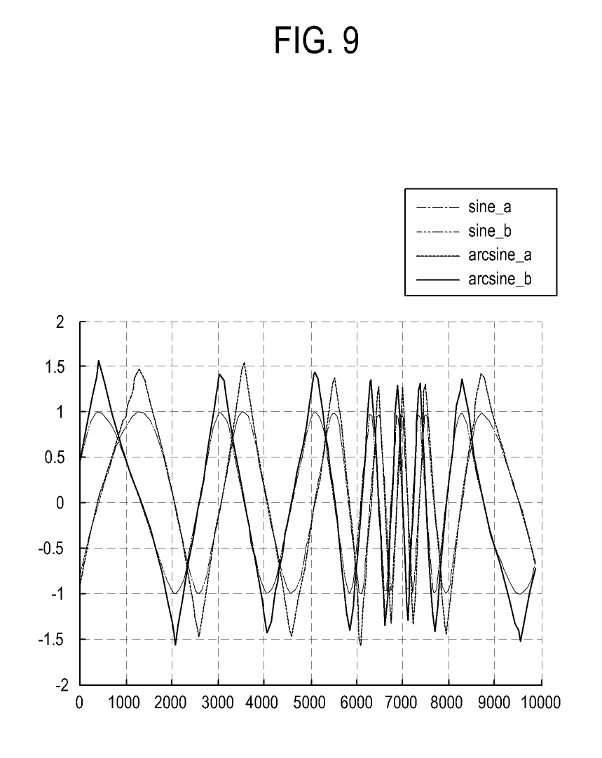

FIG. 9 represents a graph comparing the functions before and after the conversion. Referring to FIG. 9, when the curved sinusoidal function is linearized, a precision at the point where the level of increase and decrease changes is enhanced through extending a size change from between about +1 and −1 to between about +1.5 and −1.5.

In order to calculate the position of an object, S30 may output a progressing direction of the encoder apparatus and a position of the encoder apparatus. That is, S30 may include determining whether the output linear functions change their respective signs in a predetermined time period (S31), calculating information related to the increase or decrease of the encoder step (S33), and outputting the first position value (pos_1) by adjusting the position according to the increase or decrease direction of the encoder (S35).

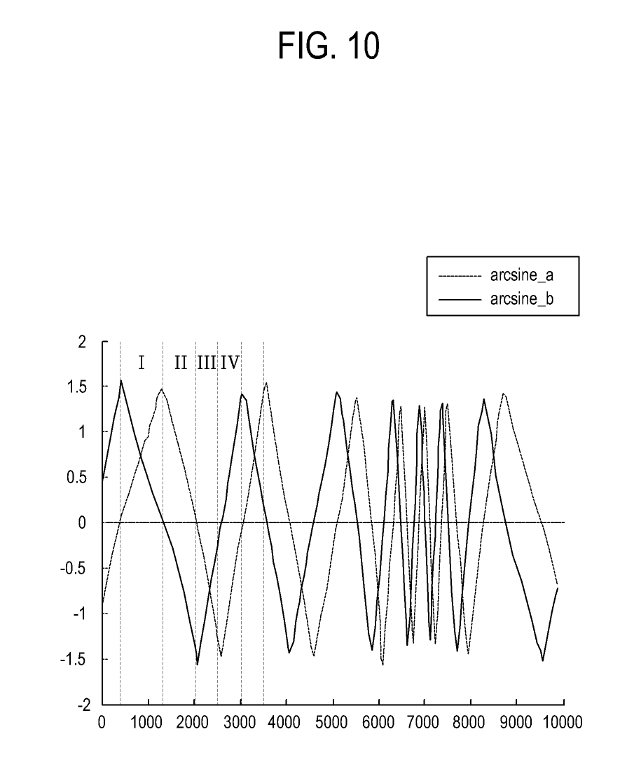

FIG. 10 is a graph illustrating processes including S31, S33 and S35 that may determine the encoder progressing direction in the time periods I, II, III AND IV,

Referring to FIG. 10, the direction can be known by updating a direction whenever the output vertical axis data signs of the respective arcsine_a and acrsine_b are updated. For example, a determination reference is represented in Table 2. Here, the rotating object is represented for example where CW represents a clockwise direction and CCW represents a counterclockwise direction.

TABLE 2

| arcsine_a value sign | | | arcsine_b value sign | | |
|---|---|---|---|---|---|
| change time point (ex, I | | | change time point (ex, II | | |
| and III regions) | | | and IV regions) | | |
| arcsine_a | arcsine_b | | arcsine_b | arcsine_a | |
| slope | sign | direction | slope | sign | direction |
| + | + | CW | − | + | CW |
| − | − | CW | + | − | CW |
| − | + | CCW | − | − | CCW |
| + | − | CCW | + | + | CCW |

For example, in the graph of FIG. 10, the time period II will be examined. Referring to FIG. 10, arcsine_b changes from a positive number (+) to a negative number (−) when the function transitions from time period I to time period II. The determination reference of Table 2 corresponds to the graph of arcsine_b since the sign of arcsine_b is changed at this point in time. Also, the number is a decrease in the position value since the arcsine_b value in the time period II is smaller than the arcsine_b value in the time period I. Also, the arcsine_a value in the time period II is positive.

Accordingly, it may be determined that a decrease of arcsine_b (slope is negative) and a positive sign of arcsine_a represents that the encoder apparatus, for example the driving plate 11, is rotating in clockwise (CW) direction. In this way, the slope and sign of the respective channel signals may used to determine the rotation direction of the driving plate.

With reference to FIGS. 5 and 10, S35 will now be explained in detail. Based on the time point when changes occur to the signals of arcsine_a and arcsine_b within the divided time periods I, II, III and IV, the first position value may be increased or decreased based on the direction information acquired in S31 and S33. For example, as illustrated in FIG. 10, the sign of arcsine_a or arcsine_b changes when the time period is changed from I to II, or II to III, respectively.

The amount of position change with respect to one time period may be determined by the resolution of the A/D converter 15. For example, if the A/D converter 15 of resolution 256 steps is used, the amount of position change becomes 256. Accordingly, the first position value (pos_1) may be represented as follows.

pos_{—}1=before_{—}pos_{—}1+256; in case of CW

pos_{—}1=before_{—}pos_{—}1−256; in case of CCW

Also, the calculating of the object position (S30) may further include calculating the second position value (pos_2) through reading the A/D converted position information for the more precise position information. That is, selecting one channel linear function among the two output channel linear functions (S41), quantizing the selected channel output value (S43), and outputting the second position value (pos_2) converted in accordance with the resolution of the A/D converter 15 (S45) may also be included. Here, if the A/D converter 15 of 256 steps resolution is used, the second position value may be represented by a value between 0 and 255.

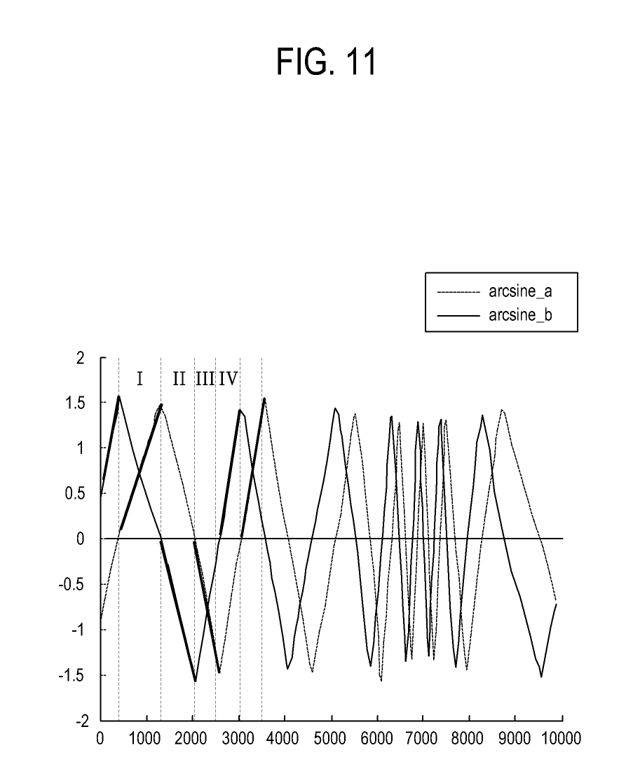

FIG. 11 is a graph illustrating a process of calculating the second position value (pos_2). First, a part to read the A/D converted values of arcsine_a and arcsine_b graph may be selected. The part of the A/D converted value to read may be selected by a state of a corresponding region as illustrated below in Table 3.

TABLE 3

| CW direction | | | CCW direction | | |
|---|---|---|---|---|---|
| arcsine_a | arcsine_b | Selected | arcsine_a | arcsine_b | selected |
| sign | sign | value | sign | sign | value |
| + | + | arcsine_a | + | + | arcsine_b |
| + | − | arcsine_b | − | + | arcsine_a |
| − | − | arcsine_a | − | − | arcsine_b |
| − | + | arcsine_b | + | − | arcsine_a |

The thick line part of graph in FIG. 11 represents a part of the selected part in the corresponding time period in the clockwise direction.

An absolute value of the read selected graph value is taken. Accordingly, the respective absolute values of arcsine_a and arcsine_b may be represented as follows.

arcsine_data=|arcsine_{—}a(x)|, absolute value of output arcsine_{—}a at position x

arcsine_data=|arcsine_{—}b(x)|, absolute value of output arcsine_{—}b at position x

For example, the vertical axis value corresponding to the horizontal axis value of 1000 position is read, approximately, arcsine_data ˜|0.8|=0.8. Also, the vertical axis value of the horizontal axis value 2000 position is read, approximately, arcsine_data ˜|−1.52|=1.52.

The read absolute value should be converted as the arcsine function output value in accordance with the resolution of the A/D converter 15.

If the A/D converter resolution is assumed to be 256 steps, the arcsine output range may be represented as follows.

−π/2˜π/2 (−1.57˜1.57).

pos_{—}2=256/1.57*arcsine_data, (CW direction)

pos_{—}2=256−256/1.57*arcsine_data, (CCW direction)

Accordingly, the second position value of the horizontal axis 1000 position may be determined as pos_2=256/1.57*0.8=130.

The object position can then be calculated through the method of summing the first position value (pos_1) and the second position value (pos_2) (S50). That is, the object position may be a summed value of pos_1 and pos_2. For example, with reference to FIG. 11, the position 386 corresponding to the horizontal axis 1000 position can be known to be from 256+130.

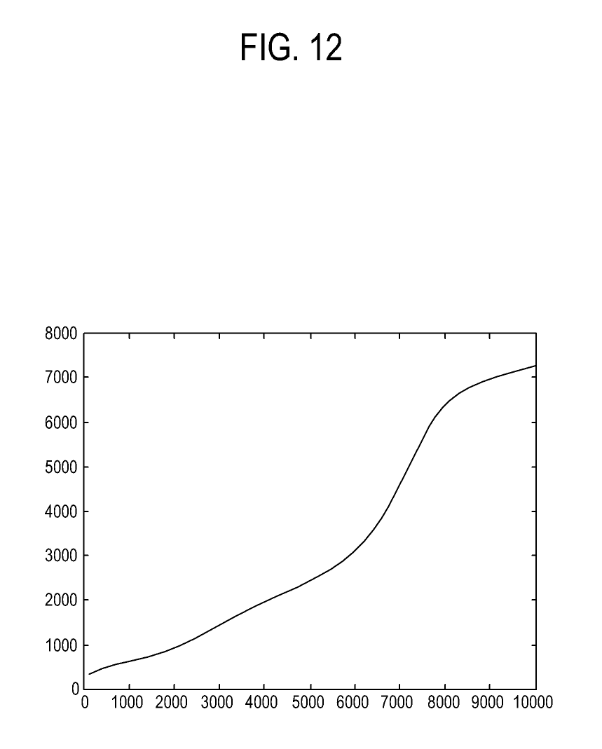

FIG. 12 illustrates a graph resulted from summing the first position value (pos_1) and the second position value (pos_2). Referring to FIG. 12, the position value may be calibrated along all the periods of the time axis. Therefore, the object position to be measured can be detected precisely in real time.

The encoder apparatus and the calibration method using this apparatus configured according to the present general inventive concept can prevent the discord problem of the output of the respective periods through converting the sinusoidal wave signal output from the optical device into a triangular wave signal.

Accordingly, the microscopic movement of the object to be measured can be precisely detected directly from the output signal converted in the A/D converter. Accordingly, the present general inventive concept may be applied to an apparatus requiring a precise varied amount of an object to be measured, for example, an inkjet printer requiring the precise detection of the rotation amount of the printing medium feeding roller in real time.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An encoder apparatus to measure a position of an object from an input analogue signal, comprising:
a driving plate to vary according to the position of the object;
an optical device to receive a light response from the driving plate and to output a sinusoidal wave analogue signal according to an amount of the driving plate's movement;
an analogue to digital (A/D) converter to output a normalized sinusoidal wave digital signal converted from the analogue signal outputted from the optical device; and
a calibration unit to convert the sinusoidal wave digital signal outputted from the A/D converter into a triangular wave signal.

2. The encoder apparatus of claim 1, the optical device outputs the analogue signal in at least two channels.

3. The encoder apparatus of claim 2, wherein the A/D converter outputs sine function output level signals having values between −1 and +1, respectively.

4. The encoder apparatus of claim 3, wherein the calibration unit comprises an inverse function converting part to output a calculated linear function by applying an inverse sine function to each of the sine function output level signals.

5. The encoder apparatus of claim 4, wherein the calibration unit further comprises:
a direction calculating part to detect whether a sign of the linear function outputted by the inverse function converting part changes in a predetermined time period, and to calculate information related to an increase/decrease direction of an encoder step; and
a position adjusting part to output a first position value according to the information related to the increase/decrease direction of the encoder step calculated in the direction calculating part.

6. The encoder apparatus of claim 5, wherein the calibration unit further comprises:
a second position acquiring part to select one of the two channels outputted in the inverse function converting part and to output a second position value by taking an absolute value of the selected channel output value converted in accordance with a resolution of the A/D converter.

7. The encoder apparatus of claim 6, wherein the calibration unit further comprises:
a position calculating part to calculate the position of the object by summing the first position value and the second position value.

8. A calibration method of an encoder apparatus to measure a position of an object from an input analogue signal, the method comprising:
outputting a normalized sinusoidal wave digital signal which is converted from a sinusoidal wave analogue signal which varies according to the position of the object;
converting the normalized sinusoidal wave digital signal into a triangular wave signal; and
calculating the position of the object from the converted triangular wave signal.

9. The calibration method of claim 8, wherein the sinusoidal wave analogue signal is obtained in at least two channels.

10. The calibration method of claim 9, wherein the outputting the normalized sinusoidal wave digital signal comprises:
calibrating to calculate encoder level maximum values and encoder level minimum values of the respective channels by driving the encoder apparatus in constant speed; and
converting to sine function output levels of the respective channels having values between −1 and +1 by using the encoder level maximum values and the encoder level minimum values of the respective channels.

11. The calibration method of claim 10, wherein the converting to the triangular wave signal comprises:
outputting a linear function by applying an inverse sine function to each of the sine function output levels of the respective channels.

12. The calibration method of claim 11, wherein the calculating the position of the object comprises:
determining whether respective signs of the output linear functions in a predetermined time period are changed;
calculating information related to an increase direction or a decrease direction of an encoder step; and
outputting a first position value by adjusting a position according to the calculated information related to the increase direction or the decrease direction of the encoder step.

13. The calibration method of claim 12, wherein the calculating the position of the object further comprises:
selecting one linear function of one channel from the output linear functions of the two channels;
quantizing an output value of the selected channel; and
outputting a second position value by converting the quantized output value proper for a resolution of a resolution of an analogue-to-digital converter;
thereby calculating the position of the object through summing the first position value and the second position value.

14. An encoder apparatus to measure movement of an object, comprising:
an optical device to output at least one sinusoidal wave signal according to a detected movement of the object; and
a calibration unit to convert the at least one sinusoidal wave signal into a linear wave signal to calculate position values of the object.

15. The encoder apparatus of claim 14, wherein the position values comprise a first position value related to a progressing direction of the object, a second position value related to a magnitude of the object's movement, and an actual position value based on a summation of the first position value and the second position value.

16. The encoder apparatus of claim 15, further comprising:
an A/D converter having a predetermined resolution value; and
wherein the first position value is calculated through addition or subtraction of the resolution value with respect to a prior position of the object based on the progressing direction of the object, and the second position value is calculated by quantizing a selected part of the linear wave signal in accordance with the resolution value.

17. The encoder apparatus of claim 15, wherein the progressing direction is determined by comparing the slope and sign of selected parts of the linear wave signals.

18. A calibration method to measure movement of an object, the method comprising:
outputting at least one sinusoidal wave signal according to a detected movement of the object;
converting the at least one sinusoidal wave signal into a linear wave signal; and
calculating position values of the object based on a selected part of the linear wave signal.

19. The calibration method of claim 18, wherein the selected part of the linear wave signal corresponds with a progressing direction of the object in a predetermined time period.
